(19) United States
(12) Patent Application Publication
(10) Pub. No.: US 2008/0282917 A1
(43) Pub. Date: Nov. 20, 2008

(54) Cylinder with reduced inertia variation and method

(75) Inventors: Richard Karl Weiler, Raleigh, NC (US); Brian Joseph Gentle, Rochester, NH (US); Daniel M. Perdue, Rochester, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 11/803,551

(22) Filed: May 15, 2007

(51) Int. Cl. B41F 13/08; B41C 1/18

(52) U.S. Cl. 101/378; 101/401.1

(57) ABSTRACT

A plate cylinder includes a cylinder including a longitudinal axis and a centroid located at a geometric center of the cylinder. The cylinder also includes a slot for receiving both ends of a printing plate; the cylinder including a counter balance hole extending axially in the cylinder and being displaced from the longitudinal axis, the counter balance hole balancing the slot; and the cylinder including a mass balance hole extending axially in the cylinder and being displaced from the longitudinal axis, the mass balance hole balancing the plate cylinder. The cylinder further including at least one hole extending axially in the cylinder and being displaced from the longitudinal axis of the cylinder to reduce the variation in products of inertia as the plate cylinder rotates. A cylinder is also provided. A method is also provided.

### BACKGROUND OF THE INVENTION

The present invention relates to the printing industry and more particularly to cylinders in a printing press susceptible to imbalanced area moment of inertia.

U.S. Pat. No. 6,131,513 discloses a plate cylinder having a plate slot. The lead edge and tail edge of a plate are situated in the plate slot. An eccentric shaft is disposed within a hole of the plate cylinder, and is preferably disposed near the plate slot.

U.S. Pat. No. 5,485,784 A1 discloses a printing plate cylinder having an elongate mounting slot with a pair of opposed slot walls. A universal lock-up apparatus is disposed within the elongate mounting slot of the plate cylinder for releasibly holding opposed edges of a printing plate against one of the opposite slot walls of the slot.

### SUMMARY OF THE INVENTION

The present invention provides a plate cylinder including:

a cylinder including a longitudinal axis and a centroid located at a geometric center of the cylinder;

the cylinder including a slot for receiving both ends of a printing plate;

the cylinder including a counter balance hole extending axially in the cylinder and being displaced from the longitudinal axis, the counter balance hole balancing the slot;

the cylinder including a mass balance hole extending axially in the cylinder and being displaced from the longitudinal axis, the mass balance hole balancing the plate cylinder; and

the cylinder including at least one hole extending axially in the cylinder and being displaced from the longitudinal axis of the cylinder to reduce the variation in products of inertia as the plate cylinder rotates.

The present invention also provides a method for designing a plate cylinder including the steps of:

selecting at least one location for at least one axially extending hole displaced from a longitudinal axis of a plate cylinder;

selecting at least one size for the at least one axially extending hole; and

the at least one location and at least one size reducing a variation in products of inertia as the plate cylinder rotates, as compared to a plate cylinder without the at least one axially extending hole.

The present invention further provides a cylinder comprising:

a cylinder including a longitudinal axis and a centroid located at a geometric center of the cylinder;

the cylinder including a mass balance hole extending axially in the cylinder and being displaced from the longitudinal axis, the mass balance hole balancing the cylinder; and

the cylinder including at least one hole extending axially in the cylinder and being displaced from the longitudinal axis of the cylinder to reduce the variation in products of inertia as the cylinder rotates.

### BRIEF DESCRIPTION OF THE DRAWINGS

A preferred embodiment of the present invention will be elucidated with reference to the drawings, in which:

FIG. 1 illustrates a cross sectional view of a prior art plate cylinder;

FIG. 2 is a chart depicting variations in cross sectional area moments of inertia variation as the plate cylinder shown in FIG. 1 rotates;

FIG. 3 schematically illustrates a process for grinding a plate cylinder;

FIG. 4 shows a view of a plate cylinder in accordance with an embodiment of the present invention;

FIG. 5 is a chart comparing variations in cross sectional area products of inertia of the prior art plate cylinder of FIG. 1 to the variations in products of inertia of the plate cylinder of FIG. 4 in accordance with the present invention; and

FIG. 6 shows a view of the plate cylinder shown in FIG. 4.

### DETAILED DESCRIPTION

The manufacturing process for printing plate cylinders is well known in the industry. Typically, the process requires cylinders to be ground within a desired tolerance. With a demand for longer width plate cylinders, for example, plate cylinders in excess of 66 inches in width, manufacturing within an allowable tolerance range has become increasingly difficult.

Specifically, manufacturers cannot meet an allowable run-out specification of, for example, 0.0002 inches, during the final grind process without having to perform secondary specialty grinding operations. These additional operations add to the cost and time to manufacture the cylinder. Even with specialty grinding operations, a cross sectional radius of the cylinder may vary, for example, by approximately 0.0005 inches, resulting in an elliptical shaped cylinder. The 0.0005-inch variation leads to poor contact between the printing plate and printing blanket, thus resulting in increased plate cylinder vibration and decreasing print quality. Ideally, the plate cylinder has a constant cross sectional radius; the plate cylinder is circular rather than elliptical shaped.

Non-uniform deflection of the plate cylinder during the grinding process causes variation in the cross sectional radius and the subsequent elliptical-shaped cylinder. Problems associated with non-uniform deflection become increasingly apparent when manufacturing longer width plate cylinders because an increase in length and weight of the plate cylinders results in increased deflection. To offset non-uniform deflection during the manufacturing process, improved inertia balance may be desired so a constant cross sectional radius of a plate cylinder may be achieved when grinding the plate cylinder as well as uniform deflection as measured in a given plane as the cylinder rotates.

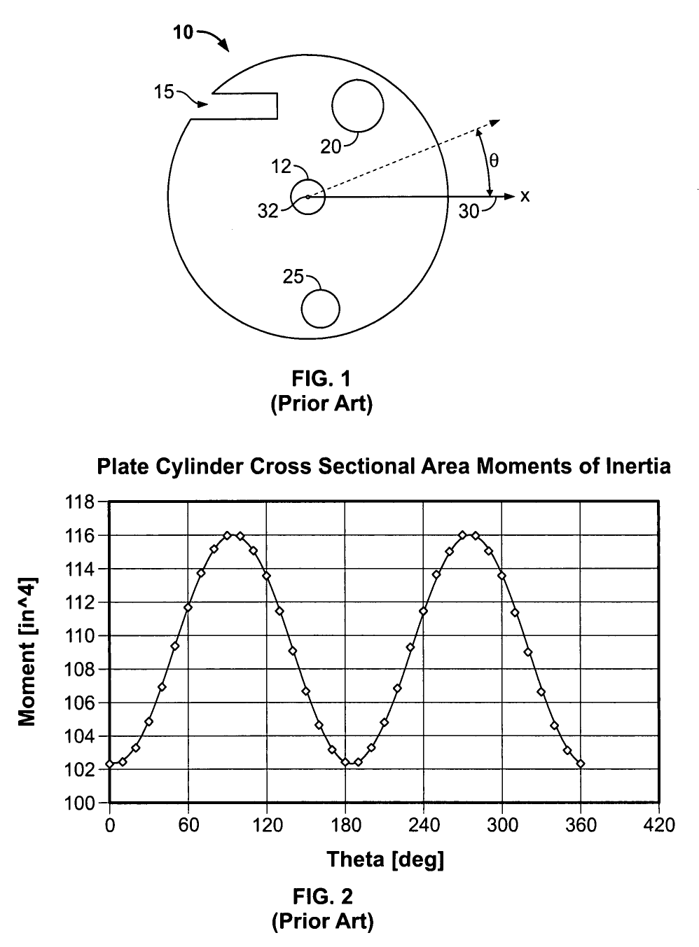

FIG. 1 shows a prior art plate cylinder 10. Generally, FIG. 1 shows a plate cylinder 10 cross section with a lock-up bar slot 15, hole 20 for lock-up bar slot counter balancing and hole 25 for mass balancing of plate cylinder 10. Also shown is an x-axis 30 normal to the surface of plate cylinder 10 with rotation angle Θ.

Plate cylinder 10 includes a lock-up bar slot 15, where a lock-up bar would be added to plate cylinder 10 after the grinding process. The lock-up bar pulls and locks a leading edge and a trailing edge of a printing plate wound around the peripheral surface of plate cylinder 10. Plate cylinder 10 includes hole 20 to counter balance lock-up bar slot 15. Without hole 20, plate cylinder 10 is unbalanced about z-axis 32. A counter weight bar may be placed inside hole 20 and connected to a lock-up bar in lock-up bar slot 15. Adding a counter weight bar reduces the centrifugal load component of the lock-up bar which may be very large and unsafe. In addition, hole 20 and the counter weight bar help balance plate cylinder 10 about z-axis 32.

Plate cylinder 10 includes an additional hole 25 for counter balancing mass about z-axis 32. Similar to hole 20, hole 25 offsets the portion of plate cylinder 10 removed to create lock-up bar slot 15 and hole 20 because the volume of mass removed to create lock-up bar slot 15 and hole 20 shifts a centroid of plate cylinder 10 away from geometric center 12. When the centroid is in a location different from geometric center 12, plate cylinder 10 vibrates during rotation. Thus, a properly located hole 25 shifting the centroid to geometric center 12 results in improved dynamic balance. However, this prior art configuration does not improve the inertia balance and bending stiffness of plate cylinder 10 as plate cylinder 10 rotates. As a result, poor inertia balance and non-uniform bending stiffness cause defects in plate cylinder 10 during the grinding process. Such defects may include, for example, variation in cross sectional radius leading to elliptical shaped cylinders.

Although holes 20 and 25 may improve dynamic balance of plate cylinder 10, variations in moments of inertia of cylinder 10 still occur. FIG. 2 shows a chart depicting area moments of inertia versus angular position theta of plate cylinder 10. More specifically, the chart shows area moments of inertia of plate cylinder 10 about x-axis 30, as plate cylinder 10 rotates through angle theta. As evident by the sinusoidal nature of the chart, the area moments of inertia vary significantly.

The moment of inertia relates to lateral deflection. Generally, the inertia and lateral deflection of the plate cylinder may be calculated using conventional mathematical modeling techniques. Specifically, the lateral deflection of the plate cylinder with respect to the plate cylinder's axis of rotation can be expressed as a second derivative as shown in the following Equations (1) and (2):

$$Equation 1 \text{:}$$

$$\frac{{d}^{2} w}{d {z}^{2}} = \frac{1}{E} \frac{{M}_{y} {I}_{xx} - {M}_{x} {I}_{xy}}{{I}_{yy} {I}_{xx} - {( {I}_{xy} )}^{2}}$$

$$Equation 2 \text{:}$$

$$\frac{{d}^{2} v}{d {z}^{2}} = \frac{1}{E} \frac{{M}_{x} {I}_{yy} - {M}_{y} {I}_{xy}}{{I}_{yy} {I}_{xx} - {( {I}_{xy} )}^{2}}$$

wherein

w=Lateral deflection in the x direction;

v=Lateral deflection in the y direction;

Mₓ=Bending moment in the x axis;

M_{y}=Bending moment in the y axis;

I_{xy}=Mixed Product of inertia;

Iₓₓ=Product of inertia in the x direction;

I_{yy}=Product of inertia in the y direction; and

E=Modulus of elasticity of material.

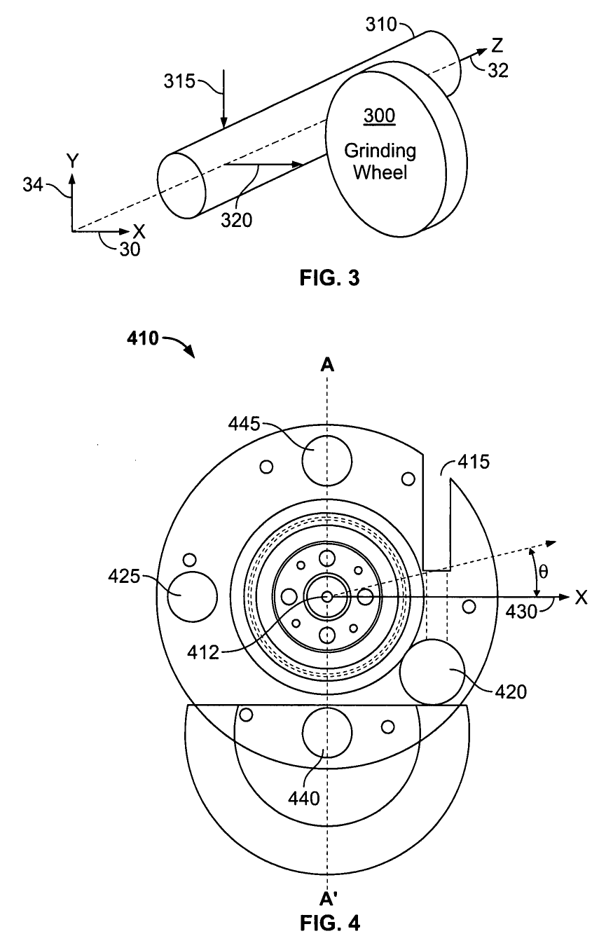

Equations (1) and (2) show the relationship between area moment of inertia, lateral deflection in the x and y axes, and the applied moments. Referring to FIG. 3, during plate cylinder manufacturing, a force due to gravity 315 is imposed in the y-axis 34 on plate cylinder 310 and a force along the x-axis 30 is imposed on plate cylinder 310 from grinding wheel 300. The principal moments of inertia are the maximum and minimum values obtained as the axis of interest is rotated. The axes where the principal moments occur are known as principal axes. Ideally, the product of inertia I_{xy} (also referred to as mixed inertia) is zero about the principal axes. When considering lateral deflection of the cylinder during the grinding process, the displacement in the y direction (shown in FIG. 3 and denoted as v in Equation (2)) and displacement in the x direction (denoted as w in Equation (1)) indicate the cylinder deflects relative to the gravity and the grinding wheel, respectively. The displacement is caused by the force of gravity and/or the force of the grinding wheel acting on the plate cylinder as well as the variation in the relevant area moments of inertia.

Theoretically, a balanced and rigid cylinder rotates without inertial or bending stiffness imbalances and has a constant cross sectional radius, the plate cylinder being circular. When the mass of plate cylinder 10 is asymmetrical, for example, when cylinder 10 includes a lock-up slot 15, the centroid shifts and causes imbalances. Holes 20, 25 are added to plate cylinder 10 to offset the cut in cylinder 10, however, holes 20, 25 only improve dynamic balance. The holes 20, 25 do not improve variations in area moments of inertia of plate cylinder 10, as shown in FIG. 2. Further, as shown above, variations in area moments of inertia are related to non-uniform deflection in plate cylinder 10 as the cylinder rotates, resulting in manufacturing defects in the plate cylinder 10.

As shown in FIG. 3, during manufacturing of plate cylinder 310, a grinding wheel 300 is placed against a surface of plate cylinder 310 and moved relative to plate cylinder 310 in the longitudinal direction, defined by z-axis 32, to carry out the grinding of plate cylinder 310. As plate cylinder 310 rotates, grinding wheel 300 moves along z-axis 32 to grind plate cylinder 310 to the desired diameter or tolerance. A force due to gravity 315 acts downward on cylinder 310 along vertical y-axis 34 and imparts a bending moment about horizontal x-axis 30, creating a cross section with a non zero product of inertia (I_{xy}, Iₓₓ, I_{yy}) and resulting in lateral deflection of plate cylinder 310. When lateral deflection occurs during this process, the desired tolerance may not be met and the cylinder may be manufactured elliptical shaped.

The above-mentioned prior art modifications and adjustments, for example, holes 20 and 25, do not improve the inertia balance or the bending stiffness of plate cylinder 10. As a result, the plate cylinder deflects non-uniformly during the grinding process and results in defects, including an elliptical shaped cylinder. In accordance with an embodiment of the present invention, a plate cylinder may have less variation in products of inertia as the plate cylinder rotates, improved bending stiffness, reduced vibration during rotation and subsequently less lateral displacement. Thus, the manufactured plate cylinders may be ground to a more desirable run-out tolerance and have less rotational disturbances during printing.

FIG. 4 shows a cross sectional view of plate cylinder 410. Cylinder 410 includes inertia balancing holes 440 and 445, in accordance with an embodiment of the present invention. Similar to FIG. 1, FIG. 4 illustrates a lock up bar slot 415, hole 420 for lock-up bar slot counter balancing, hole 425 mass balancing plate cylinder 410, an x-axis 430 normal to the surface of plate cylinder 410 and a rotation angle Θ.

Plate cylinder 410 includes lock-up bar slot 415 for pulling and locking the leading edge and trailing edge of a printing plate wound around the peripheral surface of plate cylinder 410. Plate cylinder 410 includes holes 420, 425 counter balancing lock-up bar slot 415 and shifting a centroid of cylinder 410 back to geometric center 412 similar to FIG. 1.

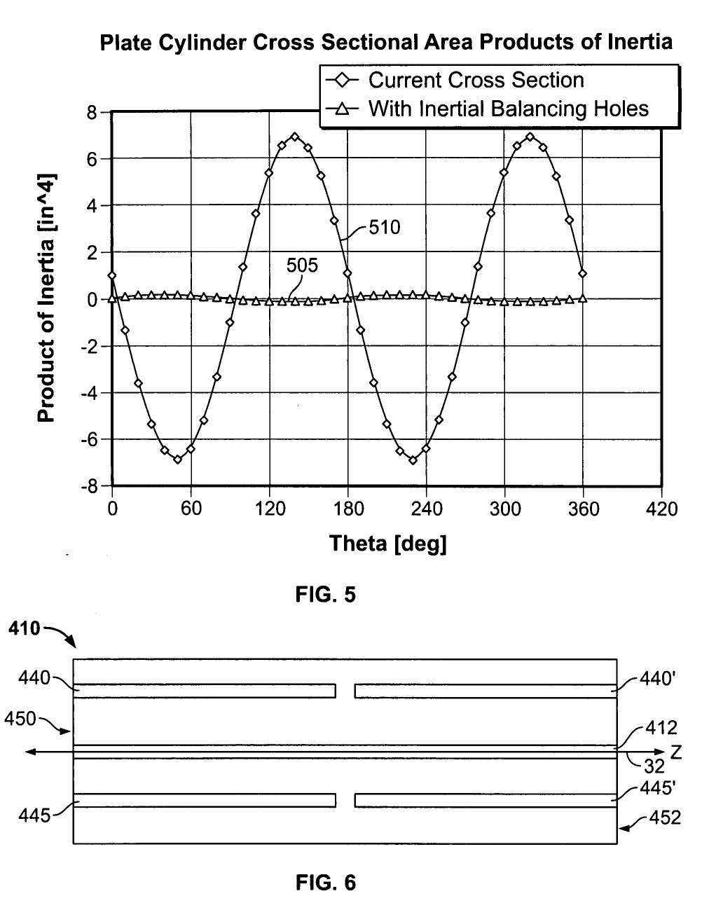

Plate cylinder 410 includes additional inertia balance holes 440, 445. Equations (1) and (2) can be used along with conventional mathematical modeling techniques to determine the placement and size of additional holes 440, 445 added to plate cylinder 410 to improve inertia balance and bending stiffness. The location and size of inertia balance holes 440, 445 are related to the plate cylinder cross sectional area products of inertia. Using modeling techniques and equations (1) and (2), hole sizes and positions in plate cylinder 410 can be selected. In a preferred embodiment, holes 440, 445 extend axially through plate cylinder 410 as shown in FIG. 6. Thus, holes 440, 445 are displaced from the longitudinal axis, (z-axis in FIG. 6), of plate cylinder 410 and varied in size and location until products of inertia are measured within a desirable criterion, as shown in FIG. 5, at chart 505.

Holes 440 and 445 minimize variations in product of inertia of plate cylinder 410 and improve bending stiffness of plate cylinder 410 during rotation. By reducing variation in the products of inertia, the displacement variations during the grinding phase of cylinder 410 are reduced similarly, as shown by Equations (1) and (2).

In a preferred embodiment shown in FIG. 6, holes 440, 440′ and 445, 445′ may be drilled from ends 450, 452 respectively of plate cylinder 410 axially inward. As shown in FIG. 6, it may be desirable to not drill holes 440, 440′ and 445, 445′ entirely through cylinder 40. Thus, holes 440 and 440′ may or may not connect. For example, holes 440 and 440′ may be spaced by a width preferably between 0.25 and 0.50 inches, for example, to accommodate manufacturing limitations.

FIG. 5 shows the variation in products of inertia as the angle of rotation Θ changes. A prior art plate cylinder chart 510 shows a large variation in products of inertia. In accordance with the present invention, a plate cylinder chart 505 shows a small variation in products of inertia when plate cylinder 410 includes two inertia balance holes 440 and 445 (FIG. 4). As shown in chart 505, the products of inertia over 360 degrees of rotation are significantly improved for plate cylinder 410 including two inertia balance holes 440, 445 (FIG. 4). As variations in products of inertia decrease, the bending stiffness uniformity improves resulting in more uniform lateral deflection. The inclusion of additional inertia balance holes 440, 445 in plate cylinder 410, as shown in FIG. 4, reduces variation in products of inertia during rotation while maintaining primary mass balance. Thus, manufacturing cylinders within tighter tolerances may be achieved.

The foregoing merely illustrates the principles of the invention. It will thus be appreciated that those skilled in the art will be able to devise numerous other arrangements which embody the principles of the invention and are thus within its sprit and scope.

For example, based on the above disclosure, it is apparent that the principles of the invention can readily accommodate various cylinder types and is not limited to print cylinders to achieve the benefits of the invention.

In addition, based on the disclosure, it is apparent that the principles of the invention is not limited to two inertia balancing holes and can readily accommodate more or less holes depending on the configuration of the cylinder.

What is claimed is:

1. A method for designing a plate cylinder comprising the steps of:
selecting at least one location for at least one axially extending hole displaced from a longitudinal axis of a cylinder; and
selecting at least one size for the at least one axially extending hole;
the at least one location and at least one size reducing a variation in products of inertia as the plate cylinder rotates, as compared to a plate cylinder without the at least one axially extending hole.

2. The method as recited in claim 1 further comprising the step of charting the products of inertia as the angle of rotation of the plate cylinder is changed.

3. The method as recited in claim 1 further comprising the step of repeating the steps of selecting at least one location and selecting at least one size until the variation in products of inertia is less than or equal to a predetermined criterion.

4. The method as recited in claim 3 wherein the products of inertia are constant.

5. The method as recited in claim 3 further comprising the step of manufacturing a plate cylinder having at least one axially extending hole in the cylinder at the at least one location and of the at least one size.

6. A plate cylinder comprising:
a cylinder including a longitudinal axis and a centroid located at a geometric center of the cylinder;
the cylinder including a slot for receiving both ends of a printing plate;
the cylinder including a counter balance hole extending axially in the cylinder and being displaced from the longitudinal axis, the counter balance hole balancing the slot;
the cylinder including a mass balance hole extending axially in the cylinder and being displaced from the longitudinal axis, the mass balance hole balancing the plate cylinder; and
the cylinder including at least one hole extending axially in the cylinder and being displaced from the longitudinal axis of the cylinder to reduce the variation in products of inertia as the plate cylinder rotates.

7. The plate cylinder as recited in claim 6 wherein the slot is a lock-up slot receiving a lead end and a trail end of a printing plate.

8. The plate cylinder as recited in claim 6 wherein the lock-up slot displaces the centroid from the geometric center.

9. The plate cylinder as recited in claim 8 wherein the mass balance hole is positioned to shift the centroid back to the geometric center.

10. The plate cylinder as recited in claim 6 wherein the at least one hole includes a first hole and a second hole, the first hole starting from a first end of the cylinder, the second hole starting from a second end of the cylinder.

11. The plate cylinder as recited in claim 10 wherein the first hole and second hole are spaced apart along the longitudinal axis.

12. The plate cylinder as recited in claim 11 wherein a space along the longitudinal axis between the first hole and second hole is between 0.25 and 0.50 inches.

13. The plate cylinder as recited in claim 6 wherein the bending stiffness is balanced as the plate cylinder rotates.

14. The plate cylinder as recited in claim 6 wherein a lock-up bar is inside the slot.

15. The plate cylinder as recited in claim 6 wherein a counter weight bar is inside the counter balance hole.

16. A cylinder comprising:
a cylinder including a longitudinal axis and a centroid located at a geometric center of the cylinder;
the cylinder including a mass balance hole extending axially in the cylinder and being displaced from the longitudinal axis, the mass balance hole balancing the cylinder; and
the cylinder including at least one hole extending axially in the cylinder and being displaced from the longitudinal axis of the cylinder to reduce the variation in products of inertia as the cylinder rotates.

17. The cylinder as recited in claim 16 wherein the at least one hole includes a first hole and a second hole, the first hole starting from a first end of the cylinder, the second hole starting from a second end of the cylinder.

18. The cylinder as recited in claim 17 wherein the first hole and second hole are spaced apart along the longitudinal axis.

19. The cylinder as recited in claim 18 wherein a space along the longitudinal axis between the first hole and second hole is between 0.25 and 0.50 inches.

20. The cylinder as recited in claim 16 wherein the bending stiffness is balanced as the cylinder rotates.
